(19) United States
(12) Patent Application Publication
(10) Pub. No.: US 2026/0320208 A1
(43) Pub. Date: Oct. 15, 2026

(54) INFORMATION PROCESSING APPARATUS, INFORMATION PROCESSING SYSTEM, INFORMATION PROCESSING METHOD, AND NON-TRANSITORY COMPUTER READABLE MEDIUM STORING PROGRAM

(71) Applicant: NEC Corporation, Minato-ku, Tokyo (JP)

(72) Inventor: Junichi SHIMOMURA, Tokyo (JP)

(73) Assignee: NEC Corporation, Minato-ku, Tokyo (JP)

(21) Appl. No.: 19/117,098

(22) PCT Filed: Oct. 20, 2022
(86) PCT No.: PCT/JP2022/039117

§ 371 Date: Mar. 31, 2025

(51) Int. Cl. G06F 21/62

(52) U.S. Cl. CPC G06F 21/6209

(57) ABSTRACT

An information processing apparatus (1) according to an example embodiment includes an issuance unit (11), an inquiry unit (12), and an output unit (13). The issuance unit (11) issues access information in response to a request from an inquired person terminal and transmits the issued access information to at least one of the inquired person terminal and an inquiry requester terminal different from the inquired person terminal. In a case where the inquiry unit (12) receives access based on the access information and inquiry data of the inquired person from the inquiry requester terminal, the inquiry unit checks the inquiry data against member data stored in advance in a predetermined storage apparatus and receives a result of the checking. The output unit (13) outputs the result of the checking to the inquiry requester terminal.

### TECHNICAL FIELD

The present disclosure relates to an information processing apparatus, an information processing system, an information processing method, and a non-transitory computer readable medium storing a program.

### BACKGROUND ART

Various techniques for preventing impersonation of a person who is to be met, including a visitor, have been proposed. For example, Patent Literature 1 discloses an entrance/exit management system that determines the appropriateness of a visitor who visits a facility by using both a visitor identification code assigned in advance and face photograph data of the visitor. According to Patent Literature 1, in a case where a person to be visited transmits information of a visitor scheduled to visit to a central processing unit at the time of registration of a visit, a management control unit of the central processing unit first determines a visit registration number for the visit and a visitor identification code (a two-dimensional code) to be assigned to the visitor. Then the management control unit transmits an e-mail to a mobile phone of the visitor and send the two-dimensional code.

Further, the management control unit transmits a request for transmission of face photograph data of the visitor himself/herself in the e-mail. After the request for transmission of face photograph data is received from the central processing unit, the visitor takes a photograph of his/her face by a camera function provided in the mobile phone and transmits it to the central processing unit. After the central processing unit receives face photograph data, it creates a visit data file.

In a case where the visitor visits, the visitor presents the two-dimensional code stored in his/her mobile phone to a photographing camera. In a case where it is determined that the corresponding visit data file is present based on the two-dimensional code, the photographing camera takes a photograph of the face of the visitor, collates and compares it with the face photograph data of the visitor registered in advance in the visit data file, and determines whether or not the visitor matches the visitor registered in advance.

### CITATION LIST

### Patent Literature

[Patent Literature 1] Japanese Unexamined Patent Application Publication No. 2011-48817

### SUMMARY OF INVENTION

### Technical Problem

In Patent Literature 1, a person to be visited needs to register visitor's information about the visit, which is troublesome. Further, the central processing unit needs to manage face photograph data transmitted from the visitor.

In view of the above-described problems, an object of the present disclosure is to provide an information processing apparatus, an information processing system, an information processing method, and a program that are capable of reducing the time and effort taken to authenticate a person who is to be met including a visitor.

### Solution to Problem

An information processing apparatus according to one example aspect of the present disclosure includes an issuance unit, an inquiry unit, and an output unit. The issuance unit issues access information in response to a request from an inquired person terminal and transmits the issued access information to at least one of the inquired person terminal and an inquiry requester terminal different from the inquired person terminal. In a case where the inquiry unit receives access based on the access information and inquiry data of the inquired person from the inquiry requester terminal, the inquiry unit checks the inquiry data against member data stored in advance in a predetermined storage apparatus and receives a result of the checking. The output unit outputs the result of the checking to the inquiry requester terminal.

An information processing system according to one example aspect of the present disclosure includes an information processing apparatus and an inquired person terminal authorized by the information processing apparatus. The information processing apparatus includes an issuance unit, an inquiry unit, and an output unit. The issuance unit issues access information in response to a request from the inquired person terminal and transmits the issued access information to at least one of the inquired person terminal and an inquiry requester terminal different from the inquired person terminal. In a case where the inquiry unit receives access based on the access information and inquiry data of the inquired person from the inquiry requester terminal, the inquiry unit checks the inquiry data against member data stored in advance in a predetermined storage apparatus and receives a result of the checking. The output unit outputs the result of the checking to the inquiry requester terminal.

In an information processing method according to one example aspect of the present disclosure, a computer performs the following processing including:
issuing access information in response to a request from the inquired person terminal and transmitting the issued access information to at least one of the inquired person terminal and an inquiry requester terminal different from the inquired person terminal;
in a case where access based on the access information and inquiry data of the inquired person are received from the inquiry requester terminal, checking the inquiry data against member data stored in advance in a predetermined storage apparatus and receiving a result of the checking; and
outputting the result of the checking to the inquiry requester terminal.

A program according to one example aspect of the present disclosure causes a computer to execute the following processing including:
issuing access information in response to a request from the inquired person terminal and transmitting the issued access information to at least one of the inquired person terminal and an inquiry requester terminal different from the inquired person terminal;
in a case where access based on the access information and inquiry data of the inquired person are received from the inquiry requester terminal, checking the inquiry data against member data stored in advance in a predetermined storage apparatus and receiving a result of the checking; and
outputting the result of the checking to the inquiry requester terminal.

### Advantageous Effects of Invention

According to the present disclosure, it is possible to reduce the time and effort taken to authenticate a person who is to be met.

### BRIEF DESCRIPTION OF DRAWINGS

FIG. 1 is a block diagram showing a configuration of an information processing apparatus according to a first example embodiment;

FIG. 2 is a flowchart for explaining a flow of an information processing method according to the first example embodiment;

FIG. 3 is a block diagram showing an overall configuration of an information processing system according to a second example embodiment;

FIG. 4 is a block diagram showing a configuration of an entrance/exit management apparatus shown in FIG. 3;

FIG. 5 is a block diagram showing a configuration of an inquired person terminal shown in FIG. 3;

FIG. 6 is a block diagram showing a configuration of an inquiry requester terminal shown in FIG. 3;

FIG. 7 is a sequence diagram showing a flow of inquiry processing of an inquired person in the information processing system according to the second example embodiment;

FIG. 8 is a diagram showing an example of a screen displayed on the inquiry requester terminal;

FIG. 9 is a block diagram showing an overall configuration of an information processing system according to a third example embodiment;

FIG. 10 is a block diagram showing a configuration of a management apparatus shown in FIG. 9; and

FIG. 11 is a block diagram showing an overall configuration of an information processing system according to a fourth example embodiment.

### EXAMPLE EMBODIMENT

Example embodiments of the present disclosure will be described hereinafter in detail with reference to the drawings. The same or corresponding elements are denoted by the same reference symbols throughout the drawings, and redundant descriptions thereof will be omitted as necessary for the clarification of the description.

In order to prevent impersonation of a visitor in a home-delivery service, a home visiting service, etc., there has been a demand for a technology for proving whether or not an identification card presented by a visitor is correct.

Meanwhile, an organization such as a company performs authentication of a member of the organization who enters the facility by using an entrance/exit management apparatus etc., thereby confirming the identity of the member on a daily basis. The example embodiments relate to a technology for verifying the identity of a third party by using authentication data of members owned by an organization.

### First Example Embodiment

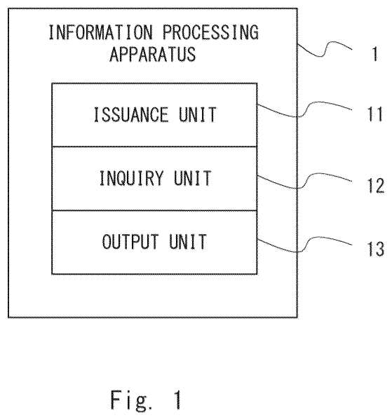

FIG. 1 is a block diagram showing a configuration of an information processing apparatus 1 according to a first example embodiment. The information processing apparatus 1 is, for example, an apparatus which, in a case where members of an organization providing a home visiting service, a home-delivery service, etc. visit customers (third parties), verifies the identities of the members for the customers. The members include not only employees of the organization but also service personnel who undertake the services provided by the organization. Examples of the services performed by the members include delivery of products purchased by customers, inspection of electricity, water, and fire extinguishers, door-to-door sales, door-to-door visits by police officers, and driving of a taxi.

Each of the organizations to which the members belong manages member data related to the respective members. In the following description, the information processing apparatus 1 verifies the identity of the member by biometric authentication using biometric information of the member. The member data includes authentication data (biometric information) of the member. Data (feature values) based on physical characteristics unique to an individual such as a face, a fingerprint, a voiceprint, a vein, a retina, and an iris of a pupil can be used as biometric information. Various techniques using photographed images can be applied as biometric authentication using biometric information.

Further, the member data may include attribute data such as the name of the organization to which the member belongs, the location of the organization, the telephone number, and the name, the age, and the gender of the member. The information processing apparatus 1 can specify attribute data related to the member in accordance with a result of the verification of the identity of the member.

A member of the organization is an “inquired person” whose identity is to be verified, and a customer is an “inquiry requester” who requests verification of the identity of the member. The “inquired person” is a person who is going to meet a customer, who meets the customer in person or meets the customer remotely, for example, through a monitor. A terminal owned by the inquired person is referred to as an inquired person terminal, and a terminal owned by the inquiry requester is referred to as an inquiry requester terminal. In the following description, an inquired person whose identity has not been verified is referred to as a “person who is to be met”, and an inquired person whose identity has been verified is referred to as a “member”.

The information processing apparatus 1 performs various types of communication with an external apparatus through a network. Note that the network may be wired or wireless, and may be of any type of a communication protocol. Specifically, the information processing apparatus 1 is connected to the inquired person terminal and the inquiry requester terminal (not shown) through the network. Note that the inquired person terminal and the inquiry requester terminal may be mobile terminals owned by a member and a customer, respectively. The inquired person terminal and the inquiry requester terminal are, for example, mobile terminals such as mobile phones, portable PCs, tablet terminals, or smartphones.

As shown in FIG. 1, the information processing apparatus 1 includes, as main components, an issuance unit 11, an inquiry unit 12, and an output unit 13. The issuance unit 11 issues access information in response to a request from the inquired person terminal and transmits it to at least one of the inquired person terminal and the inquiry requester terminal.

In a case where the access information is transmitted to the inquired person terminal, a person who is to be met displays the access information on his/her inquired person terminal and presents it to a customer. The customer reads the access information displayed on the inquired person terminal by using his/her inquiry requester terminal and accesses the information processing apparatus 1 based on the access information. Note that, in a case where the access information is transmitted to the inquiry requester terminal, the customer can access the information processing apparatus 1 based on the received access information.

Further, the customer photographs biometric information of the person who is to be met by using the inquiry requester terminal and supplies the photographed image data as inquiry data to the information processing apparatus 1. For example, the face image of the person who is to be met may be acquired by photographing the person who is to be met with a camera mounted on the inquiry requester terminal. The inquiry requester terminal can transmit the above image data to the information processing apparatus 1 through the network. Note that the inquiry requester terminal can also supply face feature information obtained by extracting feature values included in the photographed image data to the information processing apparatus 1 as inquiry data.

In a case where the inquiry unit 12 receives access based on the access information and inquiry data of the inquired person from the inquiry requester terminal different from the inquired person terminal, the inquiry unit 12 checks the inquiry data against member data stored in advance in a predetermined storage apparatus and receives a result of the checking. The output unit 13 outputs the result of the checking to the inquiry requester terminal. By outputting the result of the checking to the inquiry requester terminal in this way, the information processing apparatus 1 can verify, for the customer, the identity of the person who is to be met.

For example, the inquiry unit 12 performs face authentication on the acquired face image by using the face feature information of the member stored in the storage apparatus. If the authentication has been successfully performed, the inquiry unit 12 can also specify attribute data of the member related to the face authentication. The specified attribute data may be included in the result of the checking transmitted to the inquiry requester terminal. If the result of the checking includes the attribute data, an electronic business card with the face image of the member whose identity has been verified may be displayed on the inquiry requester terminal.

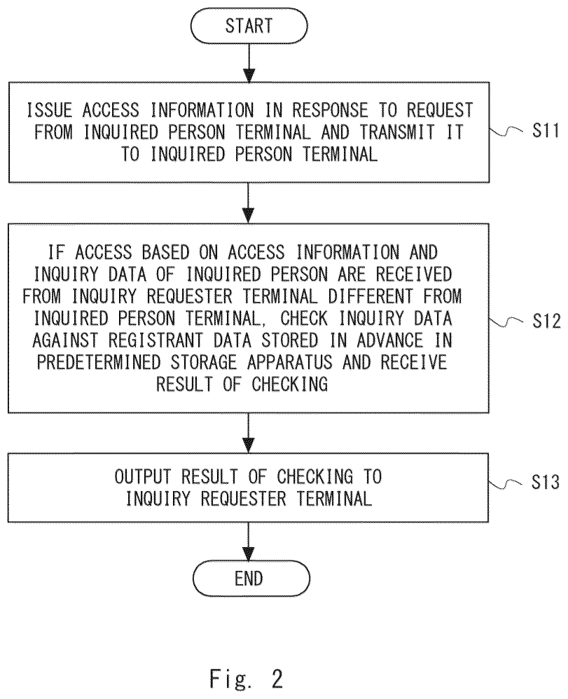

Next, processes performed by the information processing apparatus 1 will be described with reference to FIG. 2. FIG. 2 is a flowchart showing an information processing method performed by the information processing apparatus 1 according to the first example embodiment. First, the information processing apparatus 1 issues access information in response to a request from the inquired person terminal and transmits it to the inquired person terminal (S11).

Next, if the information processing apparatus 1 recieves access based on the access information and inquiry data of the inquired person from the inquiry requester terminal different from the inquired person terminal, the information processing apparatus 1 checks the inquiry data against registrant data stored in advance in the predetermined storage apparatus and receives a result of the checking (S12). Note that biometric information of a person who is to be met may be automatically generated by the inquiry requester terminal or may be generated in response to the input of a customer. Then the information processing apparatus 1 outputs the result of the checking to the inquiry requester terminal (S13).

As described above, by the information processing apparatus 1 according to the first example embodiment, it is possible to remotely verify the identity of a person who is to be met who visits a customer, and to reduce the time and effort taken to authenticate the person who is to be met. Further, the information processing apparatus 1 can prevent fraud such as impersonation of a person who is to be met who visits a customer to provide the service, and can achieve a safe service providing environment.

Note that the information processing apparatus 1 includes a processor, a memory, and a storage apparatus as components that are not shown. The storage apparatus stores a program that causes a computer to execute each of the processes of the information processing method according to the first example embodiment. The processor loads the program from the storage apparatus into the memory and executes the loaded program. As a result, the processor implements the functions of the issuance unit 11, the inquiry unit 12, and the output unit 13.

Each of the components of the information processing apparatus 1 may be implemented by dedicated hardware. Further, some or all of the components of each apparatus may be implemented by general-purpose or dedicated circuitry, a processor, or the like, or a combination thereof. These components may be formed by a single chip or by a plurality of chips connected to each other through a bus. Some or all of the components of each apparatus may be implemented by a combination of the above-described circuitry or the like and a program.

Further, a Central Processing Unit (CPU), a Graphics Processing Unit (GPU), a Field-Programmable Gate Array (FPGA), a quantum processor (a quantum computer control chip), or the like may be used as the processor.

Further, in a case where some or all of the components of the information processing apparatus 1 are implemented by a plurality of information processing apparatuses, circuits, or the like, the plurality of information processing apparatuses, circuits, or the like may be disposed in one place in a centralized manner or arranged in a discrete manner.. For example, the information processing apparatuses, the circuits, or the like may be implemented in the form of a client server system, a cloud computing system, or the like in which the information processing apparatuses, the circuits, or the like are connected to each other through a communication network. Further, the functions of the information processing apparatus 1 may be provided in the form of Software as a Service (SaaS).

### Second Example Embodiment

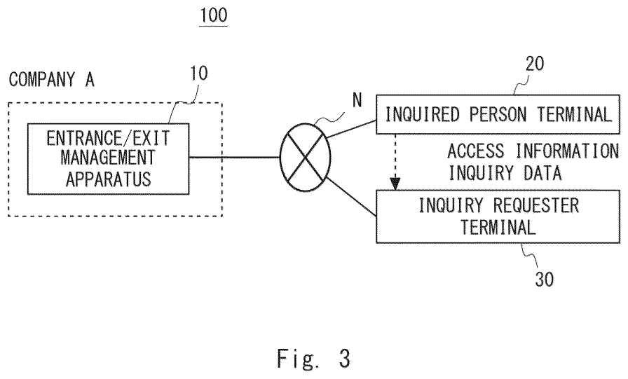

A second example embodiment is a specific example of the above-described first example embodiment. FIG. 3 is a block diagram showing an overall configuration of an information processing system 100 according to the second example embodiment. The information processing system 100 includes an entrance/exit management apparatus 10 and an inquired person terminal 20 authorized by the entrance/exit management apparatus 10, and verifies the identity of an inquired person based on a request from an inquiry requester terminal 30 under a predetermined condition. The entrance/exit management apparatus 10, the inquired person terminal 20, and the inquiry requester terminal 30 are connected to each other through a network N. Note that the network N is a wired or wireless communication line, for example, the Internet.

The information processing system 100 is a system which verifies, in a case where it is accessed from the inquiry requester terminal 30 owned by an inquiry requester (a customer) based on access information issued in response to a request from the inquired person terminal 20 owned by an inquired person (a member) and receives inquiry data of the inquired person, the identity of the inquired person. A description will be given below of an example of face authentication using a face image, which is an example of biometric information, as the inquiry data.

### <Entrance/Exit Management Apparatus 10>

The entrance/exit management apparatus 10 is an apparatus capable of managing the entrance/exit of a member belonging to an organization to a facility, thereby managing the work status of the member including his/her arriving at the office, going out of the office, returning to the office, and leaving the office. The entrance/exit management apparatus 10 includes a functional configuration of the information processing apparatus 1 described above. The entrance/exit management apparatus 10 performs information registration processing, inquiry processing for verifying the identity of an inquired person (a person who is to be met) (the information processing method according to the second example embodiment), processing for specifying attribute data of a member, and the like. The entrance/exit management apparatus 10 performs identity verification using an image obtained by photographing the person who is to be met, and outputs a result of the inquiry (i.e., a result of the verification) to the inquiry requester terminal 30.

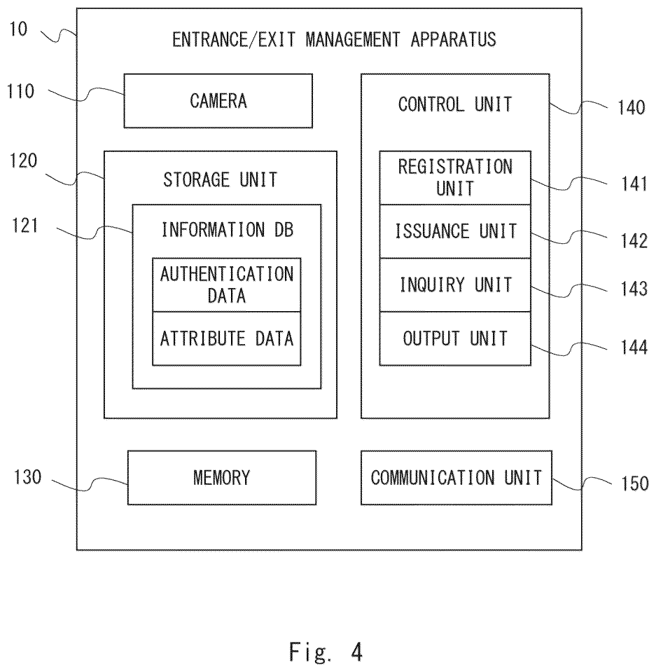

FIG. 4 is a block diagram showing a configuration of the entrance/exit management apparatus 10 shown in FIG. 3. The entrance/exit management apparatus 10 includes a camera 110, a storage unit 120, a memory 130, a control unit 140, and a communication unit 150. Note that the entrance/exit management apparatus 10 may be composed of a plurality of servers, and each functional block may be implemented by a plurality of computers.

The camera 110 is, for example, an image capturing apparatus which is installed in a facility of an organization and which captures images of the members who enter and leave the facility in accordance with the control of a control unit 26. The storage unit 120 is an example of a storage apparatus such as a hard disk or a flash memory. The storage unit 120 stores a program and an information DB 121. The program is a computer program in which a part of registration processing of face images and attribute data of the members, inquiry processing, and the like is implemented. The information DB 121 is a database in which member data including authentication data and attribute data of the members are managed. The information DB 121 can associate the authentication data and the attribute data with, for example, individual identification numbers respectively assigned to the members and manage them.

The memory 130 is a volatile storage apparatus such as a Random Access Memory (RAM), and is a storage area for temporarily holding information during the operation of the control unit 140. The communication unit 150 is a communication interface with the network N.

The control unit 140 is a processor that controls each component of the entrance/exit management apparatus 10. The control unit 140 loads the program from the storage unit 120 into the memory 130 and executes the loaded program. As a result, the control unit 140 implements the functions of a registration unit 141, an issuance unit 142, an inquiry unit 143, and an output unit 144.

The registration unit 141 registers the face image of the member photographed by the camera 110 as authentication data, and associates the input attribute data with the authentication data and registers them in the information DB 121. These data may be transmitted from the inquired person terminal 20 owned by the member described later. For example, in order to register face feature information of the member, the registration unit 141 extracts feature values from a face area included in image data and registers it as authentication data in the information DB 121.

The issuance unit 142 issues access information in response to a request from the inquired person terminal 20 and transmits it to the inquired person terminal 20. The issuance unit 11 can generate code information that can be displayed as an image such as a bar code or a two-dimensional code (a QR code (registered trademark)) as access information and transmit it to the inquired person terminal 20. The inquired person can present the received access information as an image to the inquiry requester terminal 30.

The inquiry requester terminal 30 can access the entrance/exit management apparatus 10 by reading the access information displayed on the inquired person terminal 20. Note that the issuance unit 11 may transmit the access information to the inquiry requester terminal 30. In this case, the inquiry requester terminal 30 can access the entrance/exit management apparatus 10 by using the received access information. Further, the inquiry requester terminal 30 photographs the face of a person who is to be met and supplies the photographed image data (or feature values extracted from image data) to the entrance/exit management apparatus 10 as inquiry data.

Note that a predetermined condition may preferably be set in advance in access information. The predetermined conditions include conditions related to restriction of access from the inquiry requester terminal 30 based on access information. The conditions related to restriction of access include, for example, the valid period of access information and the number of times access information can be used.

Further, the predetermined condition may be a condition that position information of the inquired person terminal 20 substantially matches position information of the inquiry requester terminal 30 or is within a predetermined range. Alternatively, the predetermined condition may be a condition that access to the entrance/exit management apparatus 10 is executed by the inquiry requester terminal 30 while the inquired person terminal 20 is accessing the entrance/exit management apparatus 10. The entrance/exit management apparatus 10 can receive access based on access information from the inquiry requester terminal 30 in a state where the predetermined condition is satisfied.

In a case where the inquiry unit 143 receives access based on access information and inquiry data of the inquired person from the inquiry requester terminal 30 different from the inquired person terminal 20, the inquiry unit 143 checks the inquiry data against member data stored in advance in a predetermined storage apparatus and receives a result of the checking. The output unit 144 returns the result of the checking to the inquiry requester terminal 30 which is the requester.

Specifically, after the inquiry unit 143 receives an authentication request of the inquired person from the inquiry requester terminal 30, the inquiry unit 143 extracts face feature information from a face image included in the authentication request. Then the inquiry unit 143 collates the face feature information extracted from the face image included in the face authentication request with the authentication data in the information DB 121, and calculates the degree of matching between them. If the degree of matching between the face feature information and the authentication data is equal to or greater than a threshold, the inquiry unit 143 outputs a result of the inquiry indicating that the face authentication has been successfully performed. Note that, in this case, the inquiry unit 143 may specify attribute data of the inquired person and also transmit the specified attribute data to the inquiry requester terminal 30. The inquiry unit 143 may output at least one of the result of the inquiry and the attribute data.

Note that if the degree of matching between the face feature information and the authentication data is less than a threshold, the inquiry unit 143 generates a result of the inquiry indicating that the face authentication has failed. The output unit 144 returns the result of the inquiry to the inquiry requester terminal 30 through the network N.

Note that, in a case where the result of the inquiry is transmitted to the inquiry requester terminal 30, the entrance/exit management apparatus 10 may create a meeting record showing that the member has met the customer. As a result, it is possible to make the members conduct fair and equitable work without violating social norms in corporate activities.

Further, the control unit 140 may receive an identification number of the inquired person from the inquired person terminal 20 and change an order of the member data to be checked with the inquiry data in accordance with the received identification number. For example, in a case where member data corresponding to the received identification number is stored in a cache and an inquiry request from the inquiry requester terminal 30 is received, the member data stored in the cache may be preferentially compared with the inquiry data. As a result, the time required for authentication of the inquired person can be reduced. Note that the member data stored in the cache may be deleted after the elapse of a predetermined time.

### <Inquired Person Terminal 20>

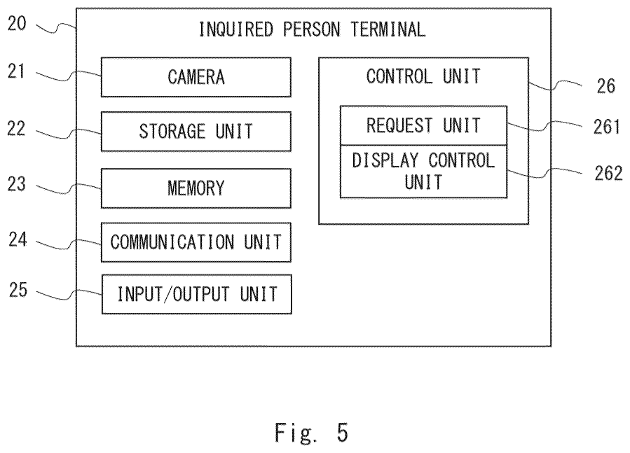

The inquired person terminal 20 is an information terminal which is owned and operated by a member who is to be an inquired person (a person who is to be met) and which transmits to and receives data from the entrance/exit management apparatus 10 through the network N by wireless communication. The inquired person terminal 20 is a mobile terminal such as a mobile phone, a smartphone, or a tablet terminal. FIG. 5 is a block diagram showing a configuration of the inquired person terminal 20 shown in FIG. 3.

The inquired person terminal 20 includes a camera 21, a storage unit 22, a memory 23, a communication unit 24, an input/output unit 25, and the control unit 26. The camera 21 is an image capturing apparatus that captures images in accordance with the control of the control unit 26. The storage unit 22 is an example of a storage apparatus including a non-volatile memory such as a flash memory or a Solid State Drive (SSD). The storage unit 22 stores a program in which processes including a process of requesting access information from the entrance/exit management apparatus 10, a process of displaying the acquired access information, and the like are implemented.

The memory 23 is a volatile storage apparatus such as a Random Access Memory (RAM), and is a storage area for temporarily holding information during the operation of the control unit 26. The communication unit 24 is a communication interface with the network N. Further, the communication unit 24 may establish a connection of short-range wireless communication with the inquiry requester terminal 30, and perform the communication. Note that various standards such as Bluetooth (registered trademark), Bluetooth Low Energy (BLE), and Ultra Wide Band (UWB) can be applied to the short-range wireless communication.

The input/output unit 25 is, for example, a touch panel including a display apparatus and an input apparatus. The control unit 26 is a processor that controls hardware included in the inquired person terminal 20. The control unit 26 loads a program from the storage unit 22 into the memory 23 and executes it. As a result, the control unit 26 implements the functions of a request unit 261 and a display control unit 262 for access information.

The request unit 261 requests the entrance/exit management apparatus 10 to issue access information through the network N in response to information input by the inquired person. The issuance unit 11 generates the access information in response to the request and transmits it to the inquired person terminal 20. The display control unit 262 causes the input/output unit 25 to display the received access information. As will be described in detail later, the inquiry requester terminal 30 can read the access information displayed on the input/output unit 25 and access the entrance/exit management apparatus 10 based on the read access information.

As described above, the face feature information of the inquired person is registered in advance as authentication data in the information DB 121 of the entrance/exit management apparatus 10. Attribute data of the inquired person is also registered in advance in the information DB 121. The authentication data and the attribute data are included in member data. Note that an authentication apparatus for performing face authentication may be provided separately from the entrance/exit management apparatus 10. In this case, the authentication data may be registered in the DB of the authentication apparatus, and the authentication data and attribute data may be associated with each other by an ID issued at the time of the registration. The display control unit 262 can display the access information received from the entrance/exit management apparatus 10 through the network N.

### <Inquiry Requester Terminal 30>

The inquiry requester terminal 30 is an information terminal which is owned and operated by a customer who is to be an inquiry requester and which transmits to and receives data from the entrance/exit management apparatus 10 through the network N by wireless communication. The inquiry requester terminal 30 is a mobile terminal such as a mobile phone, a smartphone, or a tablet terminal. Further, the inquiry requester terminal 30 may be an interphone, a monitoring camera, or the like installed in the home of an inquiry requester. The inquiry requester terminal 30 reads access information displayed on the inquired person terminal 20, and attempts to access the entrance/exit management apparatus 10 based on the access information. Further, the inquiry requester terminal 30 photographs the face of an inquired person and transmits an authentication request including the face image to the entrance/exit management apparatus 10. The inquiry requester terminal 30 receives a result of the inquiry about the inquired person and displays it.

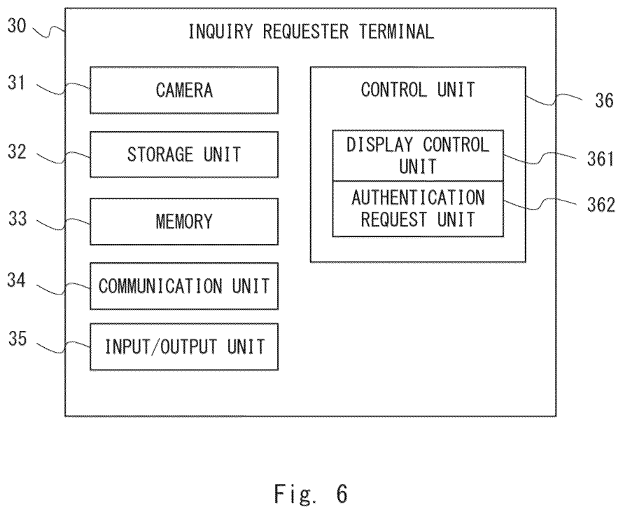

FIG. 6 is a block diagram showing a configuration of the inquiry requester terminal 30 shown in FIG. 3. As shown in FIG. 6, the inquiry requester terminal 30 includes a camera 31, a storage unit 32, a memory 33, a communication unit 34, an input/output unit 35, and a control unit 36. In this example, an image capturing apparatus and a display terminal are integrated with each other.

The camera 31 is an image capturing apparatus that captures images in accordance with the control of the control unit 36. The storage unit 32 is an example of a storage apparatus including a non-volatile memory such as a flash memory or a Solid State Drive (SSD). The storage unit 32 stores a program in which processes including a process of requesting an authentication of an inquired person described later is implemented.

The memory 33 is a volatile storage apparatus such as a Random Access Memory (RAM), and is a storage area for temporarily holding information during the operation of the control unit 36. The communication unit 34 is a communication interface with the network N. The input/output unit 35 is, for example, a touch panel including a display apparatus (a display terminal), such as a screen, and an input apparatus.

The control unit 36 is a processor that controls hardware included in the inquiry requester terminal 30. The control unit 36 loads a program from the storage unit 32 into the memory 33 and executes it. As a result, the control unit 36 implements the functions of a display control unit 361 and an authentication request unit 362.

The display control unit 361 causes the input/output unit 35 to display a result of the inquiry generated by the execution of the program. The display control unit 361 may cause the input/output unit 35 to display a message prompting an inquiry requester to photograph a face of an inquired person for face authentication.

The authentication request unit 362 extracts a face area of the person from the image obtained by photographing the inquired person by the camera 31 as a face image, and transmits an authentication request including the face image to the entrance/exit management apparatus 10. Note that the authentication request unit 362 may transmit the face feature information obtained by extracting the feature values from the face image to the entrance/exit management apparatus 10. The entrance/exit management apparatus 10 transmits a result of the inquiry about the inquired person to the inquiry requester terminal 30. If the authentication has been successfully performed, the display control unit 361 causes the input/output unit 35 to display a result of the inquiry that certifies the identity of the inquired person. The inquiry requester can confirm the validity of the identity of the inquired person by checking the result displayed on the screen.

As described above, according to the information processing system 100, it is possible to verify the identity of an inquired person in response to a request from an inquiry requester by using the entrance/exit management apparatus 10 installed in an organization to which a member belongs, and to reduce the time and effort taken to authenticate a person who is to be met.

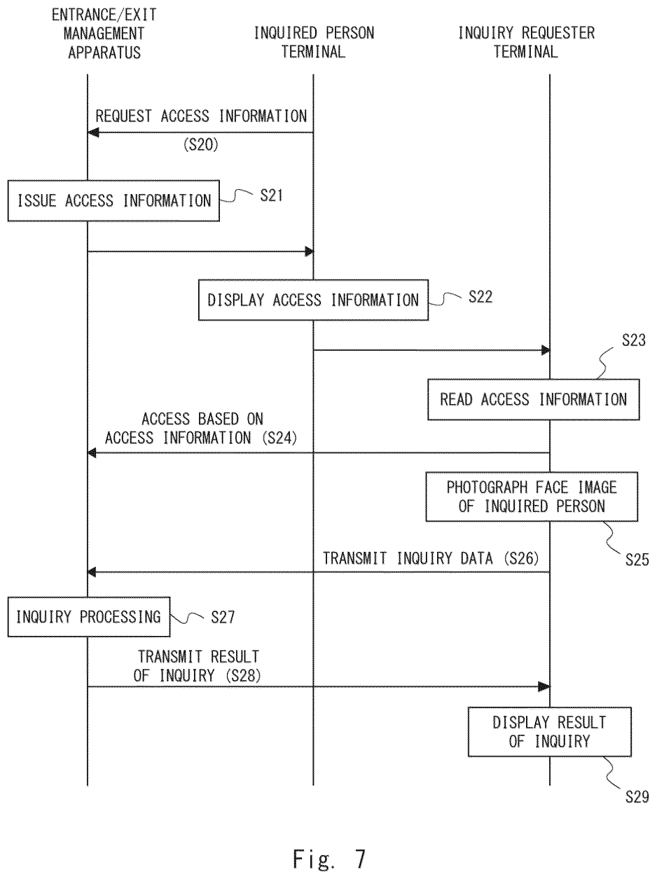

FIG. 7 is a sequence diagram showing a flow of inquiry processing of an inquired person. First, the inquired person terminal 20, which is permitted to access the entrance/exit management apparatus 10, requests the entrance/exit management apparatus 10 to issue access information (S20). The entrance/exit management apparatus 10 issues the access information (S21) and transmits it to the inquired person terminal 20. An inquired person can display the access information on the inquired person terminal 20 (S22) and present it to an inquiry requester. Note that the entrance/exit management apparatus 10 may directly transmit the access information to the inquiry requester terminal.

Then the inquiry requester terminal 30 reads the access information displayed on the screen of the inquired person terminal 20 (S23). The inquiry requester terminal 30 may read the access information presented by a person who meets the inquiry requester in person, or may read the access information presented through a monitor such as an interphone. Further, in a case where the inquiry requester terminal 30 is an interphone, it is also possible to read the access information presented by the person who meets the inquiry requester by a camera of the interphone.

Note that, in a case where a video conference or the like is conducted, the entrance/exit management apparatus 10 can also verify the identity of a caller who meets through a monitor. In this case, the inquiry requester terminal 30 can read access information of the caller presented through the monitor. Further, it is also possible, using a terminal itself on which an application program for conducting a video conference operates, to access the entrance/exit management apparatus 10 based on the access information and to acquire a face image of the caller.

After the reading of the access information is completed, the inquiry requester terminal 30 accesses the entrance/exit management apparatus 10 based on the access information (S24). At this time, a message prompting the inquiry requester to photograph the inquired person may be displayed on the screen of the inquiry requester terminal 30. Then the inquiry requester terminal 30 photographs a face image of the inquired person by using the camera 31 (S25). Then the inquiry requester terminal 30 transmits a face authentication request including the face image to the entrance/exit management apparatus 10 (S26). After the inquiry unit 143 of the entrance/exit management apparatus 10 receives the face authentication request, it performs inquiry processing (S27).

Specifically, the inquiry unit 143 extracts face feature information from the face image included in the face authentication request, collates it with authentication data in the information DB 121, and calculates the degree of matching between them. Note that, in a case where the feature values (the face feature information) extracted from the face image are transmitted from the inquiry requester terminal 30, the inquiry unit 143 collates the face feature information with the authentication data. If the face feature information matches with the authentication data, that is, if the degree of matching between the face feature information and the authentication data is equal to or greater than a threshold, a result of the inquiry indicating that the face authentication has been successfully performed is returned to the inquiry requester terminal 30 through the network N (S28). In this case, the inquiry unit 143 may specify attribute data associated with the face feature information and include the specified attribute data in the result of the inquiry. Then the inquiry requester terminal 30 displays the received result of the inquiry (S29).

Note that if the face authentication has failed, the entrance/exit management apparatus 10 can transmit the result of the inquiry indicating that the face authentication has failed to the inquiry requester terminal 30. The inquiry requester terminal 30 displays on the screen that the face authentication has failed. Further, the inquiry requester terminal 30 may notify the inquired person terminal 20 that the face authentication has failed by means of short-range wireless communication or the like.

As described above, according to the first example embodiment, it is possible to verify the identity of the member for the customer, and thus to give the customer a sense of security in a case where he/she receives a service.

Further, it is possible to prevent crimes, for example, fraud such as impersonation of the member who is going to meet the customer. Further, it is possible to secure the transparency of corporate activities by the above-described verification, and enhance compliance.

Further, since biometric information (authentication data) of the member can be centrally managed by using the entrance/exit management apparatus 10, complicated procedures and operations are not required. Further, since access information issued by the inquired person terminal 20 owned by the member and an authentication request by the inquiry requester terminal 30 owned by the customer are used to verify the identity of the member, fraud can be prevented.

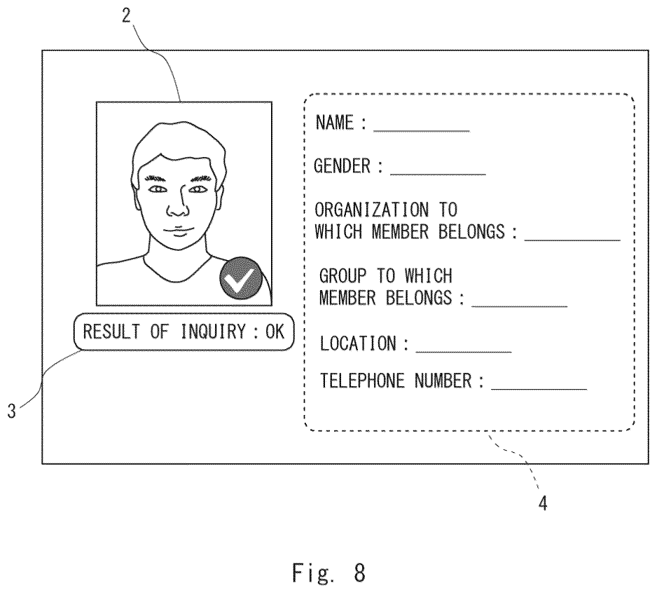

The inquiry requester terminal 30 may display an electronic business card by using attribute data output in response to the success of biometric authentication. FIG. 8 is a diagram showing an example of a screen displayed on the inquiry requester terminal 30. The screen includes an image 2 related to face authentication of an inquired person, a result display 3 of face authentication, and an information display 4.

The screen shown in FIG. 8 is obtained in a case where an owner of the inquiry requester terminal 30 has made an inquiry request of an inquired person based on access information presented by the inquired person who has visited home and then face authentication of the inquired person has been successfully performed. The information display 4 shows attribute data including the name and the like of the inquired person. Note that the attribute data shown in FIG. 8 is an example, and other information may be displayed in addition to or instead of the information shown here. The inquiry requester can let the inquired person enter his/her home without any feeling of anxiety by referring to these information pieces displayed on the inquiry requester terminal 30.

### Third Example Embodiment

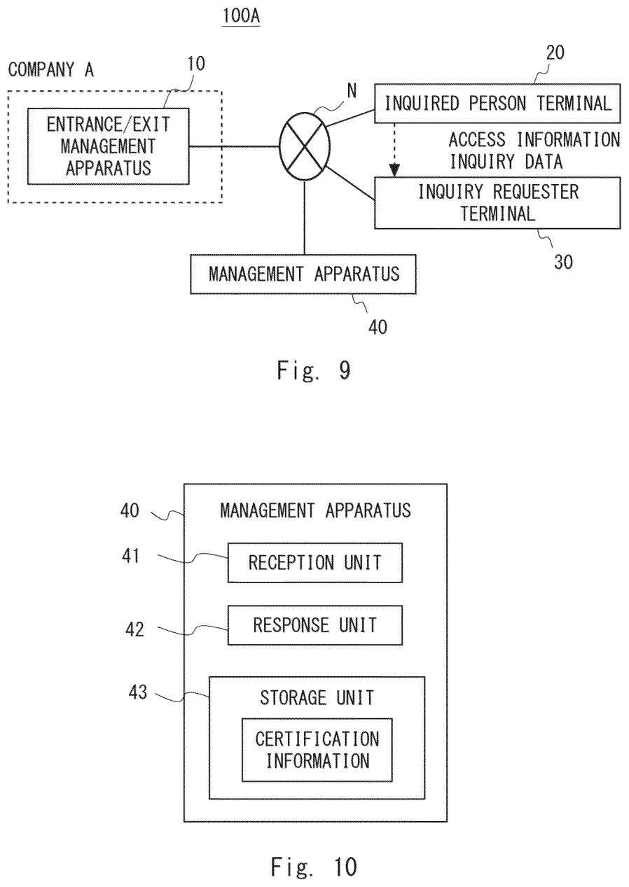

A third example embodiment is a modified example of the above-described second example embodiment. FIG. 9 is a block diagram showing an overall configuration of an information processing system 100A according to the third example embodiment. The information processing system 100A includes the entrance/exit management apparatus 10 and the inquired person terminal 20 authorized by the entrance/exit management apparatus 10, and verifies the identity of an inquired person based on a request from the inquiry requester terminal 30 under a predetermined condition.

Further, as a difference between the second and the third example embodiments, in the third example embodiment, a management apparatus 40 provides a cloud service for certifying the validity of access information issued by the entrance/exit management apparatus 10, and functions as an authentication platform. That is, the management apparatus 40 serves as a Trusted Third Party (TTP). The entrance/exit management apparatus 10, the inquired person terminal 20, the inquiry requester terminal 30, and the management apparatus 40 are connected to each other through the network N. A description will be given below with a focus on the difference between the second and the third example embodiments.

The management apparatus 40 is, for example, a cloud server, and is an authentication platform having an authentication function for certifying the validity of access information. That is, the management apparatus 40 certifies whether the access information presented by the member is issued by a reliable entrance/exit management apparatus 10.

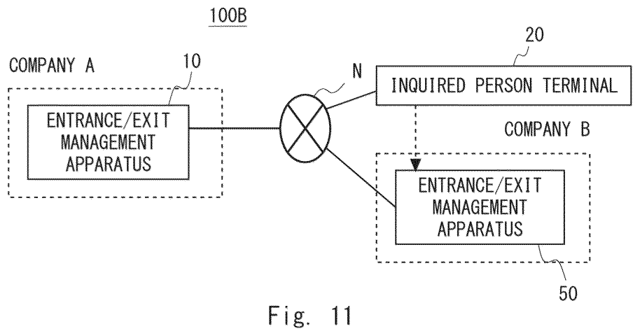

FIG. 10 is a block diagram showing a functional configuration of the management apparatus 40. As shown in FIG. 10, the entrance/exit management apparatus 10 includes a reception unit 41, a response unit 42, and a storage unit 43. Information about the entrance/exit management apparatus 10 is registered in the storage unit 43 as certification information. The information about the entrance/exit management apparatus 10 may include a company ID of an organization in which the entrance/exit management apparatus 10 is installed, access information issued to the inquired person terminal 20 accessible to the entrance/exit management apparatus 10, credit information obtained by the organization in which the entrance/exit management apparatus 10 is installed being examined in advance, and the like.

The reception unit 41 receives access information issued from the entrance/exit management apparatus 10 in a case where the entrance/exit management apparatus 10 receives an access information issue request from the inquired person terminal 20. Further, in a case where the inquiry requester terminal 30 accesses the entrance/exit management apparatus 10 based on the access information instead of or in addition to receiving access information from the entrance/exit management apparatus 10, the reception unit 41 may receive an inquiry request for the access information. Note that the access information and the inquiry request may include position information, time information, and the like of the inquired person terminal 20 and the inquiry requester terminal 30.

The response unit 42 checks the received access information with the storage unit 43, determines whether or not the access information is valid, and returns a result of the determination to the inquiry requester terminal 30. For example, the access information may include a company ID indicating an organization in which the entrance/exit management apparatus 10 is installed. The response unit 42 can determine whether or not the company ID included in the access information matches the company ID stored in the storage unit 43. Alternatively, the response unit 42 may audit the URL represented by a two-dimensional code as the access information.

Further, the response unit 42 can determine the validity of access information in response to an inquiry request for the access information from the inquiry requester terminal 30 and return a result of the determination to the inquiry requester terminal 30. Thus, a customer can access the entrance/exit management apparatus 10 based on the reliable access information without any feeling of anxiety.

Note that, in addition to the access information, the response unit 42 may determine that the access information is valid in a case where position information or time information of the inquired person terminal 20 match position information or time information of the inquiry requester terminal 30. Thus, verification of the identity of the inquired person based on illegal access information can be prevented.

### Fourth Example Embodiment

A fourth example embodiment is a further modified example of the above-described second example embodiment. FIG. 11 is a block diagram showing an overall configuration of an information processing system 100B according to the fourth example embodiment. The information processing system 100B includes the entrance/exit management apparatus 10 and the inquired person terminal 20 authorized by the entrance/exit management apparatus 10, and verifies the identity of an inquired person based on a request from an entrance/exit management apparatus 50 different from the entrance/exit management apparatus 10 under a predetermined condition. The entrance/exit management apparatus 10, the inquired person terminal 20, and the entrance/exit management apparatus 50 are connected to each other through the network N.

Note that the entrance/exit management apparatus 10 is a system that manages the entrance/exit of members belonging to a company A to the facility of the company A. Further, the entrance/exit management apparatus 50 is a system that manages the entrance/exit of members belonging to a company B different from the company A to the facility of the company B. The entrance/exit management apparatus 50 may include a configuration similar to that of the inquiry requester terminal 30 shown in FIG. 6. For example, the entrance/exit management apparatus 50 may include a camera and a monitor installed at the entrance of the company B, a control unit that transmits an authentication request of an inquired person to the entrance/exit management apparatus 10, and the like.

The entrance/exit management apparatus 50 can access, by reading access information presented by a member (an inquired person) of the company A who visits the company B with a camera installed at the entrance of the company B, the entrance/exit management apparatus 10 based on the access information. Further, the entrance/exit management apparatus 50 can capture an image of the inquired person with a camera installed at the entrance of the company B, generate a face image, and transmit an authentication request together with the face image to the entrance/exit management apparatus 10.

A result of the inquiry of the member of the company A is transmitted from the entrance/exit management apparatus 10 to the entrance/exit management apparatus 50. If the authentication has been successfully performed, the result of the inquiry that certifies the identity of the inquired person can be displayed, for example, on a monitor installed at the entrance of the company B. Thus, the entrance/exit management apparatus 50 of the company B can permit the member of the company A who is visiting to enter the company B.

Note that the entrance/exit management apparatus 50 may have substantially the same functional configuration as that of the above-described entrance/exit management apparatus 10. That is, each of the entrance/exit management apparatus 10 and the entrance/exit management apparatus 50 may have the functional configuration of the information processing apparatus 1. Thus, in a case where a member of the company B visits the company A, the identity of the member of the company B can be verified by using member data managed by the entrance/exit management apparatus 50 of the company B. That is, in this case, the identity of the visitor can be verified by mutually using member data of the company A and the company B.

Further, in a case where the company B is a financial institution and an inquired person undergoes a loan examination at this financial institution, the information processing system 100B according to the third example embodiment may be used as a system that checks whether or not the inquired person is employed by the company to which the inquired person belongs. Further, the information processing system 100B may be used to verify the identity of a bidder in a public tender by a government office, a government agency, or the like. That is, a result of the inquiry issued by the entrance/exit management apparatus 10 may be used as an official certificate of employment.

Note that the program for executing the above-described processing includes instructions (or software codes) that, in a case where it is loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storages, a magnetic cassette, a magnetic tape, and a magnetic disc storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described example embodiments and may be changed as appropriate without departing from the scope and spirit of the present disclosure. Further, the present disclosure may be implemented by combining the example embodiments with each other as appropriate.

In the above description, the identity of the member is verified by performing biometric authentication. However, the present disclosure is not limited to this example. For example, in a case where attribute data of the member is registered, a server that manages attribute data may issue an ID and a password for authentication associated with the attribute data. In this case, the identity of the member can be verified by a customer inputting the ID and the password of the member. Further, the information processing apparatus according to the example embodiments can also be incorporated into an interphone or a monitoring camera installed at home.

The whole or part of the example embodiments disclosed above can be described as, but not limited to, the following supplementary notes.

### (Supplementary Note A1)

An information processing apparatus comprising:
an issuance unit configured to issue access information in response to a request from an inquired person terminal and transmit the issued access information to the inquired person terminal;
an inquiry unit configured to, in a case where the inquiry unit receives access based on the access information and inquiry data of the inquired person from an inquiry requester terminal different from the inquired person terminal, check the inquiry data against member data stored in advance in a predetermined storage apparatus and receive a result of the checking; and
an output unit configured to output the result of the checking to the inquiry requester terminal.

### (Supplementary Note A2)

The information processing apparatus according to supplementary note A1, wherein
a predetermined condition is set in advance in the access information, and
the inquiry unit receives access based on the access information from the inquiry requester terminal in a state where the predetermined condition is satisfied.

### (Supplementary Note A3)

The information processing apparatus according to supplementary note A2, wherein the predetermined condition includes a condition related to restriction of access from the inquiry requester terminal based on the access information.

### (Supplementary Note A4)

The information processing apparatus according to supplementary note A1, wherein
attribute data related to a member is associated with the member data, and
in a case where the checking of the inquiry data has been successfully performed, the output unit outputs at least one of the result of the checking of the inquiry data and attribute data of the inquired person.

### (Supplementary Note A5)

The information processing apparatus according to supplementary note A1, wherein
the storage apparatus associates an identification number with the member data and manages the associated data, and
the information processing apparatus further comprises a change unit configured to receive an identification number of the inquired person from the inquired person terminal and change an order of the member data to be checked with the inquiry data in accordance with the received identification number.

### (Supplementary Note A6)

The information processing apparatus according to supplementary note A1, wherein the issuance unit provides the access information to the inquired person terminal so that the inquired person is able to present the access information as image data to the inquiry requester terminal.

### (Supplementary Note A7)

The information processing apparatus according to supplementary note A1, wherein the inquiry data includes biometric information acquired from the inquired person by the inquiry requester terminal.

### (supplementary Note B1)

An information processing system comprising an information processing apparatus and an inquired person terminal authorized by the information processing apparatus, wherein
the information processing apparatus comprises:
an issuance unit configured to issue access information in response to a request from the inquired person terminal and transmit the issued access information to the inquired person terminal;
an inquiry unit configured to, in a case where the inquiry unit receives access based on the access information and inquiry data of the inquired person from an inquiry requester terminal different from the inquired person terminal, check the inquiry data against member data stored in advance in a predetermined storage apparatus and receive a result of the checking; and
an output unit configured to output the result of the checking to the inquiry requester terminal.

### (Supplementary Note C1)

An information processing method performed by a computer, the information processing method comprising:
issuing access information in response to a request from the inquired person terminal and transmitting the issued access information to the inquired person terminal;
in a case where access based on the access information and inquiry data of the inquired person are received from an inquiry requester terminal different from the inquired person terminal, checking the inquiry data against member data stored in advance in a predetermined storage apparatus and receiving a result of the checking; and
outputting the result of the checking to the inquiry requester terminal.

### (Supplementary Note D1)

A non-transitory computer readable medium storing a program for causing a computer to:
issue access information in response to a request from the inquired person terminal and transmit the issued access information to the inquired person terminal;
in a case where access based on the access information and inquiry data of the inquired person are received from an inquiry requester terminal different from the inquired person terminal, check the inquiry data against member data stored in advance in a predetermined storage apparatus and receive a result of the checking; and
output the result of the checking to the inquiry requester terminal.
   (supplementary Note E1)

An information processing system comprising an information processing apparatus, an inquired person terminal authorized by the information processing apparatus, and an inquiry requester terminal different from the inquired person terminal, wherein
the information processing apparatus comprises:
an issuance unit configured to issue access information in response to a request from the inquired person terminal and transmit the issued access information to the inquired person terminal;
an inquiry unit configured to, in a case where the inquiry unit receives access based on the access information and inquiry data of the inquired person from the inquiry requester terminal, check the inquiry data against member data stored in advance in a predetermined storage apparatus and receive a result of the checking; and
unit configured to output the result of the checking to the inquiry requester terminal.

### REFERENCE SIGNS LIST

1 INFORMATION PROCESSING APPARATUS
10 ENTRANCE/EXIT MANAGEMENT APPARATUS
11 ISSUANCE UNIT
12 INQUIRY UNIT
13 OUTPUT UNIT
14 STORAGE APPARATUS
20 INQUIRED PERSON TERMINAL
21 CAMERA
22 STORAGE UNIT
23 MEMORY
24 COMMUNICATION UNIT
25 INPUT/OUTPUT UNIT
26 CONTROL UNIT
261 REQUEST UNIT
262 DISPLAY CONTROL UNIT
30 INQUIRY REQUESTER TERMINAL
31 CAMERA
32 STORAGE UNIT
33 MEMORY
34 COMMUNICATION UNIT
35 INPUT/OUTPUT UNIT
36 CONTROL UNIT
361 DISPLAY CONTROL UNIT
362 AUTHENTICATION REQUEST UNIT
40 MANAGEMENT APPARATUS
41 RECEPTION UNIT
42 RESPONSE UNIT
43 STORAGE UNIT
50 ENTRANCE/EXIT MANAGEMENT APPARATUS
100 INFORMATION PROCESSING SYSTEM
110 CAMERA
120 STORAGE UNIT
121 INFORMATION DB
130 MEMORY
140 CONTROL UNIT
141 REGISTRATION UNIT
142 ISSUANCE UNIT
143 INQUIRY UNIT
144 OUTPUT UNIT
150 COMMUNICATION UNIT
N NETWORK

What is claimed is:

1. An information processing apparatus comprising:
a memory configured to store instructions; and
a processor configured to execute the instructions to:
issue access information in response to a request from an inquired person terminal and transmit the issued access information to at least one of the inquired person terminal and an inquiry requester terminal different from the inquired person terminal;
in a case where access based on the access information and inquiry data of the inquired person are received from the inquiry requester terminal, check the inquiry data against member data stored in advance in a predetermined storage apparatus and receive a result of the checking; and
output the result of the checking to the inquiry requester terminal.

2. The information processing apparatus according to claim 1, wherein
a predetermined condition is set in advance in the access information, and
access based on the access information is received from the inquiry requester terminal in a state where the predetermined condition is satisfied.

3. The information processing apparatus according to claim 2, wherein the predetermined condition includes a condition related to restriction of access from the inquiry requester terminal based on the access information.

4. The information processing apparatus according to claim 1, wherein
attribute data related to a member is associated with the member data, and
in a case where the checking of the inquiry data has been successfully performed, at least one of the result of the checking of the inquiry data and attribute data of the inquired person is output.

5. The information processing apparatus according to claim 1, wherein
the storage apparatus associates an identification number with the member data and manages the associated data, and
the processor further configured to execute the instructions to receive an identification number of the inquired person from the inquired person terminal and change an order of the member data to be checked with the inquiry data in accordance with the received identification number.

6. The information processing apparatus according to claim 1, wherein the processor configured to execute the instructions to provide provides the access information to the inquired person terminal so that the inquired person is able to present the access information as image data to the inquiry requester terminal.

7. The information processing apparatus according to claim 1, wherein the inquiry data includes biometric information acquired from the inquired person by the inquiry requester terminal.

8. (canceled)

9. An information processing method performed by a computer, the information processing method comprising:
issuing access information in response to a request from the inquired person terminal and transmitting the issued access information to at least one of the inquired person terminal and an inquiry requester terminal different from the inquired person terminal;
in a case where access based on the access information and inquiry data of the inquired person are received from the inquiry requester terminal, checking the inquiry data against member data stored in advance in a predetermined storage apparatus and receiving a result of the checking; and
outputting the result of the checking to the inquiry requester terminal.

10. A non-transitory computer readable medium storing a program for causing a computer to:
issue access information in response to a request from the inquired person terminal and transmit the issued access information to at least one of the inquired person terminal and an inquiry requester terminal different from the inquired person terminal;
in a case where access based on the access information and inquiry data of the inquired person are received from the inquiry requester terminal, check the inquiry data against member data stored in advance in a predetermined storage apparatus and receive a result of the checking; and
output the result of the checking to the inquiry requester terminal.
